(19) United States
(12) Patent Application Publication
(10) Pub. No.: US 2009/0134549 A1
(43) Pub. Date: May 28, 2009

(54) Molding Apparatus

(76) Inventors: Hiroaki Yamamoto, Aichi Prf (JP); William H. Hardgrove, Englewood, OH (US); Rick A. Lee, Ansonia, OH (US); Andrew G. Yorde, Brookville, OH (US); Lynn K. Yorde, Brookville, OH (US)

Correspondence Address: WEGMAN, HESSLER & VANDERBURG, 6055 ROCKSIDE WOODS BOULEVARD, SUITE 200, CLEVELAND, OH, 44131, US

(21) Appl. No.: 12/086,316

(22) PCT Filed: Nov. 15, 2006
(86) PCT No.: PCT/US2006/044406

§ 371 Date: Oct. 3, 2008

Related U.S. Application Data
(60) Provisional application No. 60/749,393, filed on Dec. 12, 2005.
(60) Provisional application No. 60/843,017, filed on Sep. 8, 2006.

(51) Int. Cl. B29C 45/16

(52) U.S. Cl. 264/261; 425/556

(57) ABSTRACT

An improved molding apparatus and method of use thereof that inhibits unsightly blemishes that may be formed in molded plastic parts in caused by confined crevices of the molding apparatus. A mold cavity is formed by at least two mold portions and one of said mold portions has a molten plastic flow diverter positioned adjacent the confined crevice. The charge of molten plastic is injected into said cavity such that a portion of the charge of plastic flows over the diverter and into the confined crevice of the mold cavity. The diverter creates a narrow restriction adjacent the crevice such that the mold cavity has a larger cross-sectional area on either side of the diverter.

### CROSS REFERENCE TO RELATED APPLICATIONS

This application claims the priority benefit of U.S. Provisional Patent Application Ser. No. 60/749,393 filed Dec. 12, 2005 and U.S. Provisional Patent Application Ser. No. 60/843,017 filed Sep. 8, 2006.

### BACKGROUND OF THE INVENTION

1. Field of Invention

This invention relates to an improved method for molding articles in an injection molding apparatus.

2. Description of Related Art

It has become increasingly popular to manufacture automobile and truck trim and body parts such as fenders, bumpers, rocker panels, body panels, doors, filler panels, wheel covers, dash boards, arm rests, chin spoiler and other parts via injection molding techniques. In conventional injection molding systems and methods, an injection molded part having a show surface is formed using a mold, comprised of a first mold portion and a second mold portion that combine to form a mold cavity. Moreover, to minimize the emission of VOC compounds and to improve the aesthetic appearance of many such injection molded plastic parts, a paint film laminate covering the show surface may be placed in the mold cavity as is known in the art. The paint film laminate is placed so that a painted side of the film faces towards one of the mold portions, whereas the backing sheet of the paint film faces towards the other mold portion. The mold is then clamped closed with the paint film laminate in place, the mold cavity being formed in the space between the first and second mold portions.

A charge of thermoplastic molten resin is injected into the mold cavity so as to flow in an upstream to downstream direction. The resin fuses with the paint film in and forms the desired injection molded plastic part. After the part has been cooled in the mold, and one of the mold cavity support surfaces is displaced from the other, the part is then ejected by the use of pneumatically or hydraulically actuated lifters and the like. The lifters cooperate with one side of the mold (usually that side contiguous with the plastic substrate) and ejects or “pops” the finished part out of the mold so that another molding production cycle can occur.

When parts having narrow edges or corners are produced, such as in the case of rocker panels, chin spoilers, bumpers, etc., the flow of the plastic material tends to entrap air in the mold cavity leading to the formation of a blister or bubble in the plastic material in these corners or edges. The bubbles or blisters results in undesirable blemishes on the part. Additionally, the flow of the plastic material is inclined to push up the tip of the paint film laminate and seep between the laminate and the mold surface. The seepage of the plastic material between the paint film laminate and the mold surface forms an undesirable overflow scrap on the part. These blemishes detract from the aesthetic appearance of the part and in some instances render the part unsuitable for use. An improved molding process and system would therefore be desirable to reduce the formation of such blemishes.

### SUMMARY OF THE INVENTION

The invention is accordingly directed to methods and an apparatus for injection molding plastic parts, and more specifically for distributing the plastic material into the confined crevices in the corners and edges of the mold cavity. The methods and apparatus of the invention are designed to inhibit the formation of surface blemishes on the part that otherwise often occur as the thermoplastic plastic resin is injected into the mold cavity.

One aspect of the invention is directed to a method of molding an automobile or truck plastic part. The method includes providing a mold cavity formed by at least two mold portions, wherein the mold cavity has at least one confined crevice and one of the mold portions has at least one diverter positioned adjacent the at least one confined crevice. The method also includes injecting a charge of the plastic into the cavity such that a portion of the charge of plastic flows over the diverter and into the confined crevice of the mold cavity.

Another aspect of the invention is directed to molding apparatus. The apparatus includes a first mold part and a second mold part, the first mold part and the second mold part when positioned adjacent each other defining a mold cavity therebetween, wherein the mold cavity has at least one confined crevice. The apparatus also includes a plastic injection runner communicating with the mold cavity and adapted to inject a shot of molten plastic into and along the cavity from an upstream to a downstream direction. The apparatus also includes at least one molten plastic flow diverter extending from the first mold portion, the at least one diverter located adjacent the at least one confined crevice and configured to direct the molten plastic flow into the crevice.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawing, wherein:

FIG. 1 is a schematic sectional view of an injection molding apparatus;

FIG. 2 is a schematic sectional view taken of the injection molding apparatus taken along the plane represented by the lines and arrows 2-2 of FIG. 1 showing a lifter structure;

FIG. 3 is a sectional view of a portion of a prior art mold cavity taken;

FIG. 4 is a sectional view of a portion of the mold cavity of the molding apparatus of FIG. 1; and

FIG. 5 is another sectional view of an edge portion of the mold cavity taken along the plane represented by the lines and arrows 5-5 of FIG. 2.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

Turning now to FIG. 1, there is shown injection molding apparatus 10 with which the present invention can be utilized. Here, the molding apparatus 10 comprises a feed hopper 12 for pressurized injection of plastic material to be plasticized therein. The ejection molding apparatus 10 comprises a molding cavity 25 that is formed between a first mold portion 22 and a second mold portion 24, shown in abutting relation to form the desired mold cavity 25. Plastic material is fed into the feed hopper 12 and is then injected into the mold cavity 25 under pressure with a feed screw 14 or the like through a sprue 16. The sprue 16 communicates with a runner 18 to deliver the pressurized charge of molten plastic to the cavity 25 in the molding apparatus 10.

In the illustrated embodiment, the injection of plastic material proceeds from the runner 18 at an upstream end of the cavity 25 to a downstream end 26 of the cavity 25 to form a molded part having a plastic substrate. The ejection molding apparatus 10 is used in accordance with conventional injection molding techniques, and when a film laminate 29 is used to create a painted “show” face, conventional co-molding techniques, wherein the paint film laminate 29 is placed in the mold cavity 25 with the charge of plastic material injected into the mold along the backside of the paint film laminate. Typically, the plastic for the plastic substrate is chosen from a host of various thermoplastic and thermoset plastic materials with more common plastic substrates comprising polyvinyl chloride, polyolefins, such as polypropylene, polyacrylates such as poly(methyl)methacrylate, polyvinyl acetate, polyamides, polyimides, polyesters, phenol-formaldehyde polymers, amino polymers, polyurethanes, etc. It should be noted that the phrase paint film laminate as used herein is intended as a generic description of any film, monolayer, laminate or otherwise that is intended to impart a desired aesthetic appeal to the show surface of the part. The paint film laminate 29 can comprise a color imparting layer or layers, a transparent cast, a metallic luster or a metallic flake appearance.

Pistons 28, 30 are operatively associated with the second mold portion 24 so that this mold portion 24 may be reciprocated along rails 31, 33 between a mold formation station and a station in which the mold portion 24 is retracted upwards with regard to FIG. 1 into an open mold form. The artisan will appreciate the fact that many different arrangements can be used to displace one of the mold portions 22, 24 from the other. One example is shown in U.S. Pat. No. 5,122,051, which is incorporated by reference herein.

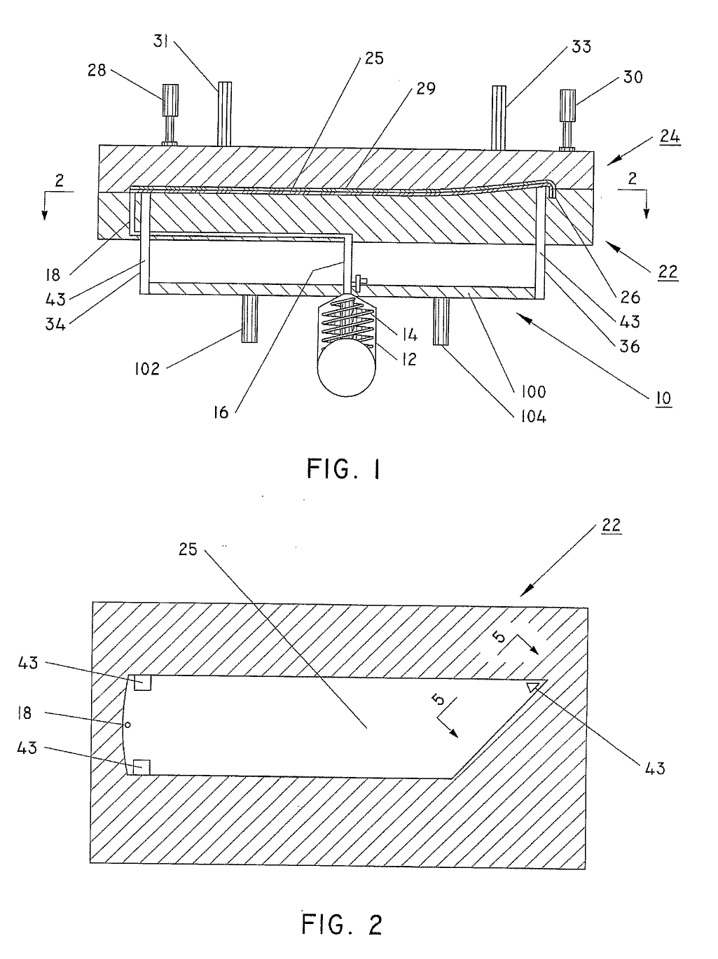

Turning also now to FIG. 2, the first mold portion 22 is desirably held stationary with a portion of the wall of the mold portion being formed via lifter structure comprising lifter pins 43 which are mounted for reciprocation by arms 34, 36 that are carried by an ejector plate 100. The ejector plate 100 is reciprocated by means of piston 102, 104. The pistons 102, 104 are actuated to move the ejector plate 100 thereby causing the lifter pins 43 to “knock” or eject the part out of the mold cavity 25. Typically, the lifter pins 43 are cylindrical members positioned near the corners of the cavity 25. In one embodiment of the invention, lifter pins 43 have a shape corresponding to the shape of the corner of the cavity 25. For example, in one embodiment, the lifter pin 43 has a generally triangular shape corresponding to the shape of the corner of the cavity 25.

Upon operation of the molding apparatus 10, the paint film laminate 29 is first inserted into the mold machine 10 along a portion of the cavity 25 defined by the contoured configuration of the second mold portion 24. Then, a sufficient shot of plastic material is injected into the molding apparatus 10 in an upstream to downstream direction from the sprue 16 and runner 18 towards the downstream end 26 of the cavity 25. As is conventional in the art, the injection of the plastic shot into the cavity 25 may be assisted via pressurized gas flow and the like, and a predetermined amount of the desired plastic material, at desired pressure and temperature is fed into the mold cavity 25. After the molded part is made in the mold cavity 25, the second mold portion 24 is retracted via the pistons 28, 30 to the open position. Then, pistons 102, 104 are actuated to move ejector plate 100, and the lifter pins 43 carried thereon toward the top to eject the part 27 out of the mold cavity 25.

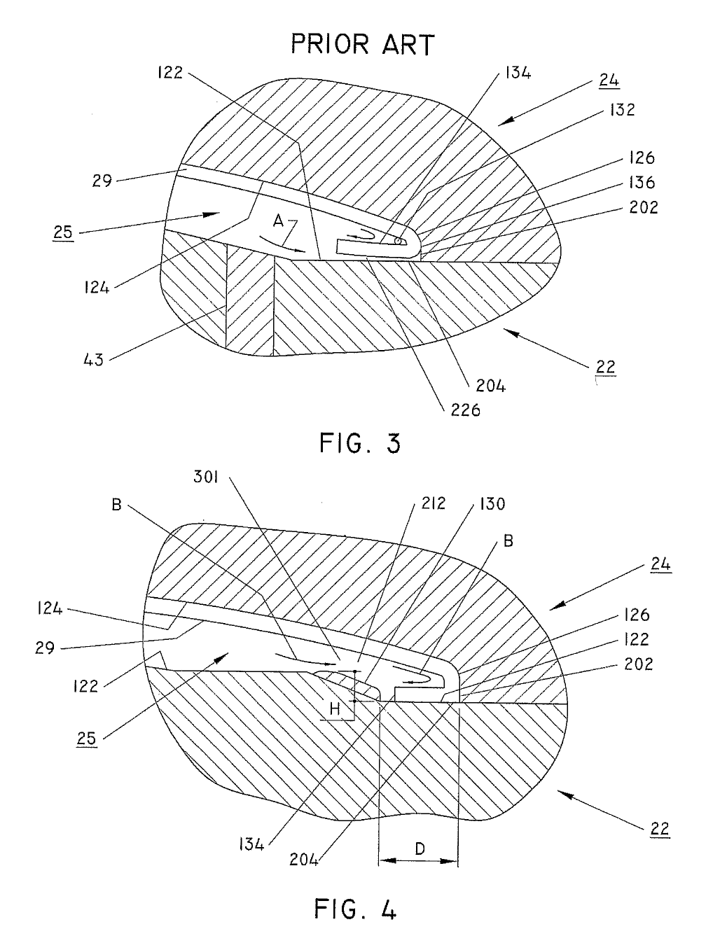

Turning now to FIG. 3, an enlarged view of a portion of a prior art mold cavity 25 in an injection molding apparatus 10 is shown illustrating the first and second mold portions 22, 24 and the mold cavity 25 formed therebetween. In the illustrated portion of the mold cavity 25, a mold surface 122 of the first mold portion 22 and a mold surface 124 of the second mold portion 24 draw together at an acute angle to form a crevice or closely bounded area, indicated at 126, at a junction of the first and second mold portions 22, 24. In the embodiment depicted in FIG. 3, the crevice 126 in the mold cavity 25 forms a corner of the molded part. Note here that a doubled or partially folded layer of paint film 29 is located in the corner or crevice 126 with the crevice being defined here as a confined corner area bounded by two intersecting walls 202, 204 of the mold portions 22, 24. In the prior art device such as that depicted in FIG. 3, the flow of the plastic material as it flows toward the crevice tends to entrap air in the crevice 126 and form a blister or bubble 132 that results in undesirable blemishes on the part. Additionally, the material is inclined to push up a tip 134 of the paint film laminate 29 so that the plastic material seeps between the paint film laminate 29 and the surface 122 of the mold portion 22 as is indicated by the arrow A which forms an overflow scrap 136, also resulting in undesirable blemishes on the part. Note the space 226 existing between surface 122 and tip 134 caused by the flow of plastic material between the paint film laminate 29 and the mold portion 22.

Turning now to FIG. 4, according to the invention a diverter 130 in the form of a convex protuberance is formed along one of the mold cavity surfaces to aid in directing the flow of the plastic material into the crevice 126. FIG. 4 illustrates an embodiment of the injection molding apparatus 10 such as might be found when the crevice 126 is located along different edges of the mold cavity 25 to form various edges of the molded part. Again, a doubled thickness of the paint film laminate 29 is present in the corner or crevice bounded by intersecting walls of the mold portions 22, 24. It is to be understood by one skilled in the art, however, that the crevice 126 may be located along any edge or in any corner of the mold cavity 25. In fact, the cavity 25 may have multiple crevices 126 without departing from the scope of the invention. Additionally, although the crevice 126 is shown at the junction of the two mold portions 22, 24, the crevice 126 may also be formed in a closely bounded portion of a single mold portion without departing from the scope of the invention.

In accordance with the invention, the diverter 130 is formed in one of the mold cavity surfaces creating a narrow restriction or throat 301 adjacent the crevice 126. As illustrated in the embodiment depicted in FIG. 4, the diverter 130 projects from the surrounding mold surface 122 of the mold wall 204 into the mold cavity 25 so that the mold cavity has a larger cross-sectional area immediately on either side of the diverter 130. Preferably, the cross-sectional area immediately upstream from the diverter with regard to plastic flow is greater than the cross-sectional area above the diverter. The diverter 130 is formed adjacent cornered boundaries or along edges to help the plastic material pack out better in these areas. The shape of the mold portions 22, 24 with the diverter 130 causes a corner or edge of the molded part to have a greater thickness than the portion of the part immediately adjacent the corner or the edge of the part. Although not intending to be bound by any particular theory, it is believed that diverter 130 increases the velocity of the flow of plastic material so that it more readily flows into the crevice 126 and dissipates any air trapped in the crevice 126, thereby reducing the possibility of the formation of bubbles or blisters in the final molded part.

Additionally, in embodiments where the film laminate 29 is provided in the co-molding process, the diverter 130 also diverts the flow of plastic material into the space 212 between the doubled or V-shaped layers of the film laminate 29 so as to adjust the angle at which the flow of plastic material impinges upon the tip 134 of the paint film laminate 29 (see arrows B representing direction of flow in FIG. 4). After flowing over the diverter 130, the flow impinges from generally above the tip 134 of the paint film laminate 29. Of course, the directions used herein are included to describe the illustrated embodiments and are not intended to be limiting. Directing the flow of the molten plastic so as to impinge upon the tip 134 of the film laminate reduces the tendency to have some of the plastic material run or seep between the paint film laminate 29 and the surface 122 of the mold portion 22 and helps press the tip 134 flat against the surface 122 so that the tip contiguously mates with the surface. As a result, surface blemishes on the show surface of the injection molded part are minimized since the film laminate 29 is disposed contiguously along each of the surfaces 122 124 of the mold cavity 25.

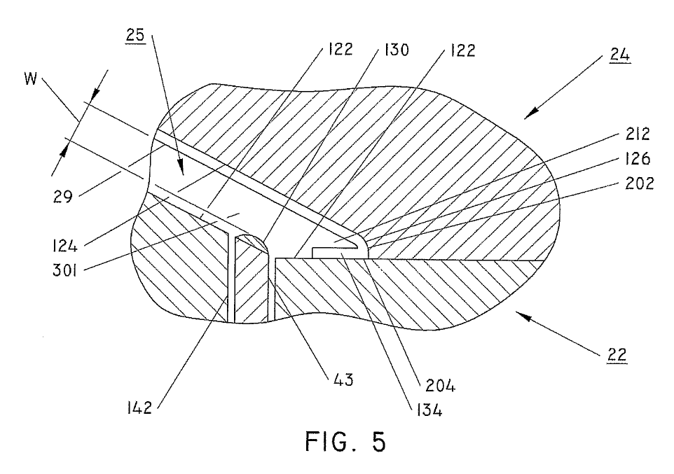

As seen in FIG. 4, the diverter is desirably positioned a distance D between about 2.0 mm and about 5.0 mm from the base of the crevice 126 at the junction between the first and second mold portions 22, 24, and in one embodiment, a distance D of about 3.5 mm. The diverter 130 also desirably has a height H of between about 0.5 and 3.0 mm, and in one embodiment a height of about 1.0 mm. As seen in FIG. 5, the narrow restriction or throat 301 between the diverter 130 and the mold surface 124 opposite the diverter 130 desirably has a width W of between about 2.0 mm and 8.0 mm, and more desirably has a width W of at least about 2.6 mm. This minimum width W is desirable so that there is sufficient space for the plastic material to flow past the diverter 130 and into the crevice 126, and also so that the molded part has a sufficient thickness in the corresponding portion of the part formed in the restricted portion of the mold. The diverter 130 can have a rounded edge as illustrated, or may have a more squared transition to the portions of the mold surface 122 on either side of the restriction.

Turning now to FIG. 5, in one embodiment the diverter 130 is formed on the lifter pin 43. Here, the diverter 130 projects from the top surface of the lifter pin 43 near crevices 126 in the corners or along edges of the mold cavity 25 as set forth above. Additionally, as seen in FIG. 5, a small air channel 142 is provided between the lifter pin 43 and the surrounding mold portion 22. The air channel 142 provides a passageway that permits gases to escape from the crevice 126 during the injection process. Desirably, the air channel 142 has a width of about 0.001 inch (0.03 mm) so as to permit air to escape through the channel 142 but substantially prevent the plastic material from entering and escaping through the channel 142. Alternatively, sealing means such as spring loaded O-rings or the like may be provided along the channel 142 to block air passage at certain points of the mold sequence and then, when actuated, allow air passage through the channel during different occasions in the molding cycle such as after the plastic and gas (if used) have been injected into the cavity and concurrent to or prior to part ejection from the cavity.

While various exemplary embodiments of the invention are described herein, the invention is not limited to the precise forms of the lifter and methods described herein. It is evident based on the description provided that many changes, alterations, variations and changes to the invention can be made without departing from the scope of the invention as set forth herein.

What is claimed is:

1. A method of molding an automobile or truck plastic part, comprising:
providing a mold cavity formed by at least two mold portions, wherein said mold cavity has at least one confined crevice and one of said mold portions has at least one diverter positioned adjacent said at least one confined crevice;
injecting a charge of said plastic into said cavity such that a portion of the charge of plastic flows over the diverter and into the confined crevice of the mold cavity.

2. The method as recited in claim 1 wherein said plastic part comprises a film covered part and wherein said film is superposed over at least a portion of said plastic part and forms a film covered face of the part leaving a rear face having an exposed plastic surface.

3. The method as recited in claim 1 wherein the diverter creates a narrow restriction adjacent the crevice.

4. Method as recited in claim 2 wherein said film comprises a double layer of material disposed in said crevice and wherein said plastic flows over said diverter into said crevice and between said double layer.

5. Method as recited in claim 4 wherein said crevice is bounded by two intersecting corner surfaces of said mold and wherein said plastic flow causes said film to position contiguously along both of said corner surfaces.

6. Method as recited in claim 4 wherein said double layer comprises an edge tip portion and wherein said plastic flow causes said film to position contiguously along one of said corner surfaces.

7. Injection molding apparatus comprising:
a first mold part and a second mold part, said first mold part and said second mold part when positioned adjacent each other defining a mold cavity therebetween, wherein said mold cavity has at least one confined crevice;
a plastic injection runner communicating with said mold cavity and adapted to inject a shot of molten plastic into and along said cavity from an upstream to a downstream direction;
at least one plastic flow diverter extending from the first mold portion, said at least one diverter located adjacent said at least one confined crevice and configured to direct the molten plastic flow into said crevice.

8. Apparatus according to claim 7 further comprising a moveable lifter operatively associated with said mold cavity and adapted to eject said plastic part after said first and second mold portions have been separated, wherein said at least one diverter is located on said lifter.

9. Apparatus according to claim 8 further comprising an air channel between the lifter and the surrounding mold portion, wherein the air channel provides a passageway that permits air to escape from the crevice during the injection process.

10. Apparatus according to claim 9 wherein the air channel has a width of about 0.001 inch (0.03 mm).

11. Apparatus as recited in claim 6 further comprising a film positioned in said mold cavity with a double layer of said film positioned in said crevice, said diverter adapted to divert flow of said molten plastic into said crevice and between said double layers.

12. Apparatus as recited in claim 11 wherein said crevice is bounded by two intersecting corner surfaces of said mold cavity, said diverter adapted to divert flow of said molten plastic so that said film is positioned contiguously along both of said corner surfaces.
